(19) United States
(12) Patent Application Publication
(10) Pub. No.: US 2015/0100222 A1
(43) Pub. Date: Apr. 9, 2015

(54) AUTOMATED HOLDING METHOD FOR A VEHICLE ON A SLOPE

(71) Applicant: Dr. Ing. h.c. F. Porsche Aktiengesellschaft, Stuttgart (DE)

(72) Inventors: Ulrich Beger, Weissach (DE); Alfred ADEN, Weissach (DE); Michael SCHÄFER, Steinheim (DE)

(21) Appl. No.: 14/507,060

(22) Filed: Oct. 6, 2014

(30) Foreign Application Priority Data
Oct. 7, 2013 (DE) 102013111063.0

(51) Int. Cl. B60T 8/32

(52) U.S. Cl. CPC B60T 8/32
USPC 701/116

(57) ABSTRACT

A method for holding a vehicle, in particular a motor vehicle, on a slope in an automated manner, wherein a vehicle driver allows the vehicle to stop on the slope, wherein the vehicle rolls on the slope in a manner largely uninfluenced by the vehicle driver, and wherein, after this, the vehicle is brought to a hold position in an automated manner. Also, a computer program product, to a processing device or a computer unit, and to a safety device or a safety system, in particular a driver-assistance system, for a vehicle, in particular a motor vehicle.

### CROSS-REFERENCE TO RELATED APPLICATIONS

This application claims priority under 35 U.S.C. §119 of German Patent Application No. 10 2013 111 063.0, filed Oct. 7, 2013, which is incorporated by reference herein in its entirety.

### FIELD OF INVENTION

The invention relates to a method for holding a vehicle, in particular a motor vehicle, on a slope in an automated manner. The invention further relates to a computer program product, to a processing device or a computer unit, and to a safety device or a safety system, in particular a driver-assistance system, for a vehicle, in particular a motor vehicle.

### BACKGROUND

Active and passive safety is one of the priorities when developing current and also future motor vehicles and safety systems for said motor vehicles. Known safety or driver-assistance systems in the field of the active safety of occupants of motor vehicles, that is to say for preventing the motor vehicle itself from being involved in an accident, include, for example, an electronic stability program ESP (ESC, Electronic Stability Control) for stabilizing the motor vehicle by braking intervention operations and possibly enhancing the ESP by additional automatic steering intervention operations.

A so-called hill-climb assistant (hill holder; HHC, Hill Hold Control) of a safety or driver-assistance system of a motor vehicle, that is to say also a hybrid vehicle for example, serves to assist a vehicle driver in an automated manner in holding his motor vehicle on a slope and driving away (again), wherein the hill-climb assistant can make use of a convenience function of the ESP system of the motor vehicle. The hill-climb assistant can prevent the motor vehicle from rolling back when said motor vehicle is held and driven away on the slope.

DE 10 2011 008 363 A1, which is incorporated by reference herein, discloses a method for driving and operating a drive train of a motor vehicle for holding the motor vehicle which is situated on a slope. In this case, a vehicle driver brings the vehicle to a standstill on the slope by operating a brake pedal, wherein the parked motor vehicle is automatically held on the slope by means of a service brake. If the vehicle driver requests at least one specific drive torque, the motor vehicle is started, the service brake of said motor vehicle is released and the motor vehicle drives away.

US 2005/0017580 A1 (DE 10 2004 035 089 A1), which are incorporated by reference herein, teaches a brake system having a roll-back prevention means for a hybrid vehicle, wherein the hybrid vehicle is automatically held on a slope when a vehicle driver removes his foot from a brake pedal. In this case, the hybrid vehicle is brought to a standstill on the slope by the brake pedal being operated. In order that an internal combustion engine does not have to run for the purpose of roll-back prevention during the stationary period, the hybrid vehicle is held on the slope by means of its service brake.

US 2010/0036564, which is incorporated by reference herein, A1 discloses a driver-assistance system for a motor vehicle for driving on slopes, wherein a large number of strategies are taught which a hold function of the driver-assistance system can execute when the motor vehicle is on a slope. With these strategies, the motor vehicle always comes to a standstill on the slope, either during forward travel or reverse travel, by operation of a brake pedal.

### SUMMARY

One object of the invention is to provide an improved and/or enhanced method for holding a vehicle (vehicle in question), in particular a motor vehicle, on a slope in an automated manner. A further object of the invention is to specify a computer program, a computer unit or a processing device, and a safety device or a safety system, in particular a driver-assistance system, for a vehicle, in particular a motor vehicle, which correspond to said method.

In this case, the method according to aspects of the invention is intended to be able to cooperate with an existing safety or driver-assistance system, for example of the vehicle, in order to increase the effectiveness of said safety or driver-assistance system. The method is intended to operate in a safe and reliable manner and also is intended to be cost-effective to implement. In this case, the method according to aspects of the invention is intended to be able to be implemented using a sensor system and/or an actuator system which are/is already incorporated in the vehicle.

An object of the invention is achieved by a method for holding a vehicle, in particular a motor vehicle, on a slope in an automated manner, wherein a vehicle driver allows the vehicle to stop on the slope, wherein the vehicle rolls on the slope in a manner largely uninfluenced by the vehicle driver, wherein, after this, the vehicle is brought to a hold position in an automated manner.

An object of the invention is achieved by means of a computer program product having program coding means which are designed to carry out the automated holding method for a vehicle when the program coding means are run on a processing device or are stored on a computer-readable data storage medium.

An object of the invention is achieved by means of a processing device or a computer unit, preferably a controller or control device for a vehicle, in particular a motor vehicle, wherein the computer unit or the processing device is designed in such a way that an automated holding method, wherein a vehicle driver allows the vehicle to stop on the slope, wherein the vehicle rolls on the slope in a manner largely uninfluenced by the vehicle driver, wherein, after this, the vehicle is brought to a hold position in an automated manner, can be carried out and/or a computer program produce, having program coding means which are designed to carry out the automated holding method when the program coding means are run on a processing device or are stored on a computer-readable data storage medium, can be run by said computer unit or processing device.

An object of the invention is achieved by means of a safety device or a safety system, in particular a driver-assistance system, wherein the safety device or the safety system is set up in such a way that an automated holding method, where a vehicle driver allows the vehicle to stop on the slope, wherein the vehicle rolls on the slope in a manner largely uninfluenced by the vehicle driver, wherein, after this, the vehicle is brought to a hold position in an automated manner, can be carried out by said safety device or safety system, a computer program product having program coding means which are designed to carry out the automated holding method when the program coding means are run on a processing device or are stored on a computer-readable data storage medium being implemented in said safety device or safety system and/or said safety device or safety system having a processing device or a computer unite wherein the computer unit or the processing device is designed in such a way that the automated holding method can be carried out and/or the computer program product can be run by the computer unit or processing device.

Advantageous developments, additional features and/or advantages of the invention can be found in the dependent claims and the following description.

### DETAILED DESCRIPTION

In the method according to aspects of the invention for holding a vehicle (can also be called the vehicle in question) in an autonomous, automatic or automated manner, a vehicle driver allows the vehicle to stop on a slope, wherein the vehicle can roll and/or rolls on the slope in a manner largely uninfluenced by the vehicle driver, and wherein, after this, the vehicle can be brought and/or is brought to a hold position in an automated manner. That is to say the method can be carried out by a hold function according to aspects of the invention of the vehicle (see below) or is carried out by the hold function.

According to aspects of the invention, the vehicle can be brought to the hold position by itself or the vehicle is brought to the hold position by itself. In this case, the vehicle can be handled in such a way or is handled in such a way that a speed of the vehicle decreases in a manner largely uninfluenced by the vehicle driver, that is to say by the vehicle itself. That is to say, the speed of the vehicle decreases largely on account of the slope—and permanently existing and substantially non-optional mechanical frictional conditions (drive train as a whole, tires/road etc.) in/on the vehicle.

In this case, “uninfluenced” is intended to mean, in particular, that the vehicle driver does not perform any or any significant deceleration measures—for example apart from shifting a selector lever of the vehicle—before, in particular immediately before, the vehicle comes to a standstill. A major portion or main amount of the deceleration of the vehicle when said vehicle stops on the slope is achieved, according to aspects of the invention, by an increase in a potential energy of the vehicle. Furthermore, steering movements by the vehicle driver can be disregarded according to aspects of the invention.

In this case, the slope can be greater than 3%, 4%, 5%, 6%, 7% or 8% in each case ±0.2% to ±0.4%. In this case, the vehicle driver can allow the vehicle to stop on the slope during forward travel or reverse travel. According to aspects of the invention, the vehicle can roll and/or rolls on the slope in a manner uninfluenced by a vehicle brake and/or an accelerator pedal, wherein the vehicle can be brought and/or is brought to its hold position in an automated manner.

That is to say, the accelerator pedal of the vehicle may possibly be easily operated, whereas the vehicle brake is largely unoperated. Operation of the accelerator pedal may possibly be used to achieve a position of the vehicle which is desired by the vehicle driver, for example spatially in front of or downstream of an apex of the slope. In the event of rolling of the vehicle being detected, it is preferred according to aspects of the invention for the vehicle driver to remove his foot from the accelerator pedal before the vehicle comes to a standstill, possibly shortly before said vehicle comes to a standstill.

In embodiments of the invention, the method can be carried out independently of a position of the selector lever of the vehicle or is carried out independently of the position of the selector lever. Furthermore, the method can be carried out independently of a position of the selector lever which can be newly selected and/or is newly selected during the method, or is carried out in a corresponding manner, wherein the method according to aspects of the invention can be carried out and/or is carried out when a speed of the vehicle is preferably below a crawling speed.

According to aspects of the invention, the vehicle can be held on the slope immediately after rolling on the slope by pressure being built up in an ESP system of the vehicle or the vehicle is held on the slope in a corresponding manner. Pressure is preferably built up in the ESP system at least up to a substantially minimum brake pressure which is required depending on the slope, or pressure is built up to this level when the method is carried out.

In the method according to aspects of the invention, after a comparatively long period of time, the hold position of the vehicle can be ensured by an electric parking brake being applied or activated in an automated manner or is ensured after the comparatively long period of time. That is to say, the service brake which is preferably operated by the ESP is replaced by the parking brake when holding the vehicle on the slope, that is to say the service brake is released and the parking brake is set or activated.

The automated holding method can further be carried out at a drive torque which is requested by the vehicle driver by means of the accelerator pedal and which is excessively low, or is carried out in a corresponding manner. In this case, holding of the vehicle on the slope can be assisted or else replaced by means of the accelerator pedal. Pressure can be actively built up, in particular by the ESP system, in the event of the vehicle rolling back against the desired direction of travel, or said pressure is actively built up in a corresponding manner.

According to aspects of the invention, the automated holding method can be terminated or the automated holding method is terminated when the selector lever of the vehicle can be and/or is shifted to a neutral position N or to a parking lock P, a reversal of a desired direction of travel of the vehicle can be indicated and/or is indicated and/or can take place and/or takes place, and/or the parking brake of the vehicle can be closed and/or is closed.

In the event of a desire of the vehicle driver to drive away being able to be identified and/or being identified, in particular in the event of the vehicle driver requesting a specific drive torque, the vehicle can possibly be started or the vehicle may be started. Furthermore, the service brake or the parking brake can be released or the service brake or the parking brake is released subsequently. Thereafter, the vehicle may possibly be driven away in an automated manner or the vehicle may be driven away in an automated manner.

According to aspects of the invention, the automated holding method can be terminated by means of a brake pressure reduction ramp, in particular of the ESP system, or is terminated according to aspects of the invention by means of the brake pressure reduction ramp. After the hold position has been assumed, the vehicle driver can be requested to take control of the vehicle, this involving, for example, applying the parking brake.

According to aspects of the invention, the automated holding method can be used or applied in a driver-assistance system of a vehicle in order to increase the traffic safety. The computer program according to aspects of the invention has program coding means which are designed to carry out an automated holding method according to aspects of the invention when the program coding means are run on an electronic processing device and/or are stored on a computer-readable data storage medium.

The processing device according to aspects of the invention or the computer unit according to aspects of the invention, preferably a controller or a control device of the vehicle, is designed or set up in such a way that an automated holding method according to aspects of the invention can be carried out by said processing device or computer unit. Furthermore, a computer program according to aspects of the invention can be executed by the processing device or the computer unit, or the computer program can be run on said processing device or said computer unit.

The safety device according to aspects of the invention or the safety system according to aspects of the invention, in particular the driver-assistance system, is set up in such a way that an automated holding method according to aspects of the invention can be executed by said safety device or safety system. Furthermore, a computer program product according to aspects of the invention can be implemented in the safety device or the safety system and/or said safety device or safety system can have a processing device and/or computer unit according to aspects of the invention. A driver-assistance system of this kind can have, for example, a hill-climb assistant.

According to aspects of the invention, a conventional holding method can be enhanced, and therefore made more secure, by the autonomous, automatic or automated hold function according to aspects of the invention. The holding method according to aspects of the invention can be integrated, for example, into the existing hill-climb assistants or cooperate with a relevant method in order to increase the efficiency of said method. The method according to aspects of the invention can operate in a secure and reliable manner and is cost-effective to implement since the method can be implemented with a sensor system or actuator system which is already installed in a vehicle.

The invention is explained in greater detail below, proceeding from the prior art, on the basis of exemplary embodiments of a specific embodiment.

It goes without saying that the invention is not restricted to the exemplary embodiments described below, but rather can be applied very generally to methods in which a vehicle driver allows his vehicle, in particular a motor vehicle (also hybrid vehicle), to roll on a slope without operating a device which is designed especially for comparatively strong deceleration of the vehicle, for example a vehicle or service brake, in particular in the event of freewheeling or coasting.

The methods, strategies and scenarios taught in the prior art all disclose actively decelerated stopping of the vehicle by means of the service brake on a slope. After the vehicle comes to a standstill on the slope, an assistance function of a driver-assistance system of the vehicle, for example a hill-climb assistant as mentioned in the introductory part, takes over the process of holding the vehicle on the slope, without the vehicle rolling back, by means of the service brake.

A conventional hold function is a convenience function which uses an ESP system of the vehicle, wherein the vehicle can be held in a hydraulic manner over a relatively long period of time by means of the service brake on slopes of greater than 5% when a direction of travel desired by the vehicle driver is uphill and in one plane, but here only in an active ACC mode (Adaptive Cruise Control). The service brake is released when it is identified that the vehicle driver wishes to drive away, for example on account of a drive torque being requested.

If the vehicle is brought to a standstill on a slope by the vehicle driver applying a brake, a brake pressure which was initially applied by the vehicle driver is maintained by an ESP hydraulic unit during the stationary state. The vehicle is held on the slope by the activated conventional hold function. If the brake pressure which is applied by the vehicle driver is too low and the vehicle rolls back, pressure is actively built up by the ESP system up to a required brake pressure.

According to aspects of the invention, a functional scope of the assistance function of the vehicle, for example of the hill-climb assistant, is enhanced in such a way that not only the vehicle being held on the slope by means of the service brake in an actively decelerated manner, but additionally passive rolling of the vehicle on the slope without operation of the service brake is also taken into account. That is to say, a basic idea of the invention is to hold the vehicle on a slope without the vehicle driver having to operate a brake pedal in the process, even when said vehicle is rolling on the slope, in particular by pressure being actively built up in an ESP system.

According to aspects of the invention, this is called an enhanced autonomous, automatic or automated hold function which can carry out the autonomous, automatic or automated holding method according to aspects of the invention. If the vehicle comes to a standstill, for example in a desired direction of travel uphill (most common case) with a slope of preferably more than 5%, without the vehicle driver applying a brake, according to aspects of the invention a brake pressure is actively built up by an ESP hydraulic unit when the vehicle is at a standstill and as a result the hold function according to aspects of the invention is activated in order to hold the vehicle on the slope.

That is to say, the vehicle is brought to a hold position on the slope in an automatic or automated manner when the vehicle rolls on the slope in a manner largely uninfluenced by the vehicle driver and comes to a standstill. In this case, it is preferred according to aspects of the invention to operate or set up the service brake of the vehicle in an automated or automatic manner, preferably using the ESP system.

If the vehicle is held by the hold function according to aspects of the invention, without a drive-away request and without the vehicle driver operating the brake pedal over a comparatively long period of time, for example at least 2 min, 3 min, 4 min, 5 min, 6 min, 7 min, 8 min or 10 min±0.3 min in the process, a transfer can be made to an electric parking brake (EPB, Electric Parking Brake). If, in another case, a drive torque which is requested by the vehicle driver by means of an accelerator pedal is too low and the vehicle threatens to roll back, possibly in spite of the accelerator pedal being operated, the vehicle is held in a stationary state by the hold function according to aspects of the invention and does not roll back.

If it is identified, that is to say detected, that the vehicle is rolling back against the desired direction of travel, for example owing to a loss of brake pressure due to a valve leak, when the hold function is active, pressure is additionally actively built up according to aspects of the invention, in particular by the ESP, up to a preferably minimum brake pressure which is required depending on the slope. The minimum brake pressure which is required depending on the slope is in this case particularly selected in such a way that the vehicle can be held on the slope. A brake pressure which is largely independent of the slope can also be used.

In order to start or to begin reducing pressure from the activated hold function after a drive-away request is identified, the accelerator pedal should be operated by the vehicle driver. The brake pressure is reduced when the motor or drive torque which is required for driving away is exceeded. In vehicles with a manual transmission, it is sufficient for the vehicle driver to engage the clutch, without operating the accelerator pedal.

If a selector lever of the vehicle is shifted to a neutral position N or to a parking lock P when the hold function is active, or if a desired direction of travel of the vehicle is reversed, the hold function according to aspects of the invention can then be terminated, for example by means of a brake pressure reduction ramp, or the hold function is terminated by the brake pressure reduction ramp. If, furthermore, the electric parking brake is applied when the hold function is active, the hold function, in particular of the ESP, can be terminated by means of the brake pressure reduction ramp or the hold function is terminated by means of the brake pressure reduction ramp.

The invention can also be used when the vehicle driver, in the event of rolling, operates a brake only slightly and in such a way that a brake pressure which is built up by said operation would not be sufficient to hold the vehicle on the slope, and therefore the vehicle would roll back on the slope after it comes to a standstill. In a case of this kind, a vehicle electronics system can correspondingly intervene, carry out the method according to aspects of the invention and therefore hold the vehicle securely on the slope with the brake not being sufficiently operated.

Detection of the vehicle driver allowing his vehicle to stop on the slope can be carried out in the manner taught in the prior art. In addition, rolling of the vehicle, as defined above (no or insufficient operation of a brake, possibly slight operation of the accelerator pedal, possibly any desired position of the selector lever, possibly a changing position of the selector lever etc.), should still be detected.

The method according to aspects of the invention can be carried out both during forward travel and also during reverse travel of the vehicle on the slope. In the case of forward travel, the vehicle threatens to roll backward without sufficient brake operation, and in the case of reverse travel, the vehicle threatens to roll forward without sufficient brake operation. In one exemplary embodiment, the method according to aspects of the invention can be stopped and started again by the vehicle driver.

In order to visually indicate that the vehicle is in a hold functional state by virtue of the method, a hold indicator which is already integrated in a combination instrument of the vehicle is preferably used. This hold indicator is driven initially by the activated hold function in a vehicle which is securely stopped in the stationary state. If the hold function, that is to say the hydraulic hold function of the ESP system, is deactivated and the vehicle is no longer securely held, the hold indicator is switched off, preferably immediately, that is to say without delay.

If the hold function is set up, an acoustic and/or haptic indication can be used in addition to or as an alternative to the visual indication.

1. A method for holding a vehicle, in particular a motor vehicle, on a slope in an automated manner, wherein a vehicle driver allows the vehicle to stop on the slope, wherein
the vehicle rolls on the slope in a manner largely uninfluenced by the vehicle driver, wherein, after this, the vehicle is brought to a hold position in an automated manner.

2. The automated holding method of claim 1, wherein the vehicle rolls on the slope in a manner largely uninfluenced by a vehicle brake and/or an accelerator pedal, wherein the vehicle is brought to the hold position in an automated manner.

3. The automated holding method of claim 1, wherein the method is carried out independently of a position of a selector lever of the vehicle, and/or the method is carried out independently of a position of the selector lever which is newly selected during the method.

4. The automated holding method of claim 1, wherein the vehicle is held on the slope immediately shortly before or after rolling on the slope by pressure being built up in an ESP system of the vehicle.

5. The automated holding method of claim 1, wherein:
after a comparatively long period of time, the hold position of the vehicle is ensured by an electric parking brake being activated in an automated manner;
the automated holding method is carried out at a drive torque which is requested by the vehicle driver by means of an accelerator pedal and which is excessively low; and/or
pressure is actively built up in the event of the vehicle rolling back against the desired direction of travel.

6. The automated holding method of claim 1, wherein the automated holding method is terminated when:
a selector lever of the vehicle is shifted to a neutral position or to a parking lock;
a reversal of a desired direction of travel of the vehicle is indicated and/or takes place; and/or
the parking brake of the vehicle is activated.

7. The automated holding method of claim 1, wherein, in the event of a desire of the vehicle driver to drive away being identified by the vehicle driver requesting a specific drive torque, the vehicle may be started, the service brake is released and the vehicle may be driven away in an automated manner.

8. The automated holding method of claim 1, wherein:
the slope is greater than 3%, ±0.2% to ±0.4%;
the vehicle driver allows the vehicle to stop on the slope during forward travel and/or reverse travel; and/or
after the hold position has been assumed, the driver of the vehicle is requested to take control of the vehicle.

9. A computer program product having program coding means which are designed to carry out the automated holding method for a vehicle of claim 1 when the program coding means are run on a processing device or are stored on a computer-readable data storage medium.

10. A processing device or computer unit, preferably a controller or control device for a vehicle, in particular a motor vehicle, wherein
the computer unit or the processing device is designed in such a way that an automated holding method, wherein a vehicle driver allows the vehicle to stop on the slope, wherein
the vehicle rolls on the slope in a manner largely uninfluenced by the vehicle driver, wherein, after this, the vehicle is brought to a hold position in an automated manner, can be carried out and/or a computer program product, having program coding means which are designed to carry out the automated holding method when the program coding means are run on a processing device or are stored on a computer-readable data storage medium, can be run by said computer unit or processing device.

11. A safety device or safety system for a vehicle, in particular a driver-assistance system for a motor vehicle, wherein
the safety device or the safety system is set up in such a way that an automated holding method, wherein a vehicle driver allows the vehicle to stop on the slope, wherein
the vehicle rolls on the slope in a manner largely uninfluenced by the vehicle driver, wherein, after this, the vehicle is brought to a hold position in an automated manner, can be carried out by said safety device or safety system, a computer program product having program coding means which are designed to carry out the automated holding method when the program coding means are run on a processing device or are stored on a computer-readable data storage medium being implemented in said safety device or safety system and/or said safety device or safety system having a processing device or a computer unit wherein the computer unit or the processing device is designed in such a way that the automated holding method can be carried out and/or the computer program product can be run by the computer unit or processing device.

12. The automated holding method of claim 4, wherein pressure is built up in the ESP system at least up to a substantially minimum brake pressure which is required depending on the slope.

13. The automated holding method of claim 8, wherein:
the slope is greater than 4%±0.2% to ±0.4%.

14. The automated holding method of claim 13, wherein:
the slope is greater than 5%±0.2% to ±0.5%.

15. The automated holding method of claim 14, wherein:
the slope is greater than 6%±0.2% to ±0.6%.

16. The automated holding method of claim 15, wherein:
the slope is greater than 7%±0.2% to ±0.7%.

17. The automated holding method of claim 16, wherein:
the slope is greater than 8%±0.2% to ±0.8%.
